(19) United States
(12) Patent Application Publication
(10) Pub. No.: US 2026/0233609 A1
(43) Pub. Date: Aug. 13, 2026

(54) NOTIFICATION DEVICE, NOTIFICATION METHOD, AND NOTIFICATION SYSTEM

(71) Applicant: HONDA MOTOR CO., LTD., Tokyo (JP)

(72) Inventors: Masaki Maruyama, Wako-shi (JP); Takahiro Matsuoka, Wako-shi (JP); Tatsuya Iwasa, Wako-shi (JP)

(21) Appl. No.: 19/446,349

(22) Filed: Jan. 12, 2026

(30) Foreign Application Priority Data
Feb. 13, 2025 (JP) 2025-021547

(51) Int. Cl. B60K 35/28; G06V 20/58

(52) U.S. Cl. CPC B60K 35/28; G06V 20/58

(57) ABSTRACT

A notification device includes: a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and a notification section that notifies a risk of the collision between the first mobile object and the second mobile object to an occupant of the first mobile object. The notification section changes a notification form, based on the first time allowance.

### INCORPORATION BY REFERENCE

The present application claims priority under 35 U.S.C. § 119 to Japanese Patent Application No. 2025-021547 filed on Feb. 13, 2025. The content of the application is incorporated herein by reference in its entirety.

### BACKGROUND OF THE INVENTION

### Field of the Invention

The present invention relates to a notification device, a notification method, and a notification system.

### Description of the Related Art

Conventionally, a technology of notifying, to an occupant of a mobile object, the risk of colliding with another mobile object has been known. For example, the specification of U.S. Patent Application Publication No. 2024/0078906 discloses a driver assistance system that outputs a low-level alert when another vehicle is visible for a driver, and outputs a high-level alert when another vehicle is not visible for the driver.

However, the specification of U.S. Patent Application Publication No. 2024/0078906 does not disclose a specific scheme for determining whether another vehicle is visible. Accordingly, it is difficult to say that the specification of U.S. Patent Application Publication No. 2024/0078906 can appropriately change alert levels according to a situation requiring a change in alert level, so there is a possibility that an appropriate alert cannot be provided to a driver.

The present invention has been made in view of the circumstances as described above, and an objective thereof is to make it possible to appropriately notify the risk of colliding with another mobile object.

### SUMMARY OF THE INVENTION

An aspect of the present invention is a notification device including: a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and a notification section that notifies a risk of the collision between the first mobile object and the second mobile object to an occupant of the first mobile object, wherein the notification section changes a notification form, based on the first time allowance.

According to the present invention, the risk of colliding with another mobile object can be appropriately notified.

### BRIEF DESCRIPTION OF THE DRAWINGS

FIG. 1 shows a configuration of a notification system;

FIG. 2 shows a configuration of a notification device;

FIG. 3 is a diagram for describing calculation of a first time allowance; and

FIG. 4 is a flowchart showing operation of the notification device.

### DETAILED DESCRIPTION OF THE INVENTION

### 1. Outline of Notification System

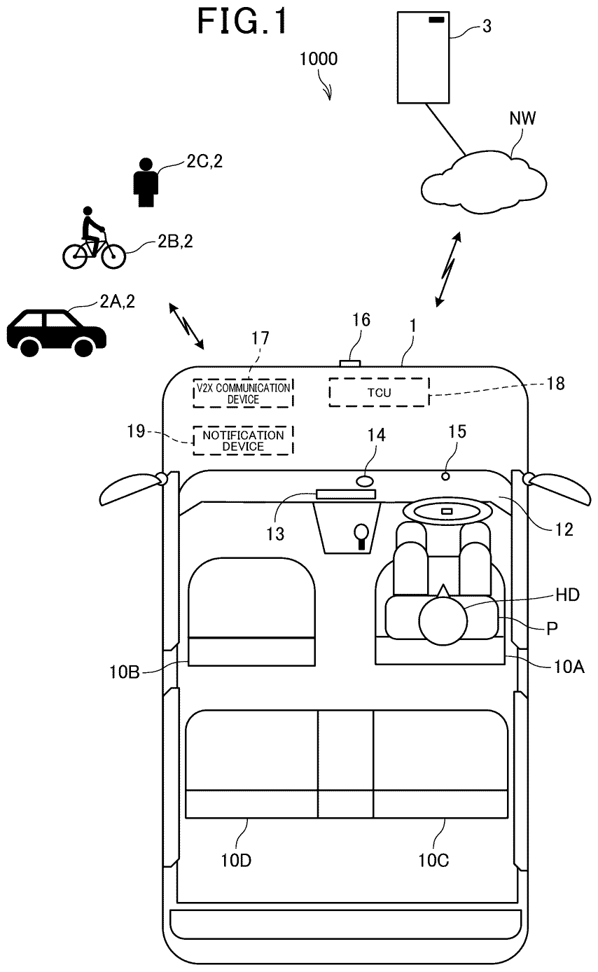

An outline of a notification system 1000 according to an embodiment is described with reference to FIG. 1.

FIG. 1 shows a configuration of the notification system 1000.

The notification system 1000 is a system to notify the risk of a collision between a first mobile object 1 and a second mobile object 2, to an occupant P of the first mobile object 1. In FIG. 1, another vehicle 2A, a bicycle 2B, and a pedestrian 2C are depicted as second mobile objects 2.

The notification system 1000 includes a notification device 19 provided to the first mobile object 1, and a server device 3 connected to a network NW that is a wide area network (WAN). The server device 3 is a device that processes information for the notification device 19 as a client.

In FIG. 1, a configuration of the first mobile object 1 is shown. The first mobile object 1 illustrated in the present embodiment is a four-wheel vehicle. The first mobile object 1 includes a driver seat 10A, a passenger seat 10B, a rear right seat 10C, and a rear left seat 10D. In the first mobile object 1 in FIG. 1, a driver is sitting in the driver seat 10A and is on board as an occupant P.

The first mobile object 1 includes a dashboard 12. A touch panel 13 and a speaker 14 are installed on the dashboard 12. The touch panel 13 is configured by superposing or integrating a display panel, which displays characters and images, and a touch sensor, which detects a touch on the display panel. The speaker 14 outputs sound toward a space in a vehicle cabin of the first mobile object 1. Note that the location of the speaker 14 and the number of speakers 14 can be changed arbitrarily.

The first mobile object 1 includes a driver monitoring camera 15. The driver monitoring camera 15 is a camera that is placed at a predetermined location in the vehicle cabin of the first mobile object 1, and that captures a driver sitting in the driver seat 10A. The capturing range of the driver monitoring camera 15 is a range including at least the head HD of the driver sitting in the driver seat 10A. The driver monitoring camera 15 performs capturing at predetermined intervals in cases such as when an ignition of the first mobile object 1 is on or when an accessory power supply of the first mobile object 1 is on. Each time the driver monitoring camera 15 performs capturing, image data on a captured image (hereinafter, referred to as “driver captured image”) obtained by the capturing is outputted to the notification device 19.

The first mobile object 1 includes a front camera 16 that captures a scene ahead of the first mobile object 1. The front camera 16 is placed in a front portion of the first mobile object 1 and captures a scene ahead of the first mobile object 1. The front camera 16 performs capturing at predetermined intervals in cases such as when the ignition of the first mobile object 1 is on or when the accessory power supply of the first mobile object 1 is on. Each time the front camera 16 performs capturing, image data on a captured image (hereinafter, referred to as “front captured image”) obtained by the capturing is outputted to the notification device 19.

The first mobile object 1 includes a vehicle-to-everything (V2X) communication device 17 (transmitter/receiver, circuit). The V2X communication device 17 communicates with the other vehicle 2A by performing vehicle-to-vehicle communication. The V2X communication device 17 communicates with a terminal carried by a person (the pedestrian 2C or an occupant of the bicycle 2B) existing around the first mobile object 1 by performing vehicle-to-pedestrian communication.

The first mobile object 1 includes a telematics control unit (TCU) 18 (transmitter/receiver, circuit). The TCU 18 is a communication device that communicates with equipment connected to the network NW.

The first mobile object 1 includes the notification device 19. The notification device 19 is a device that notifies the risk of a collision between the first mobile object 1 and a second mobile object 2.

### 2. Configuration of Notification Device

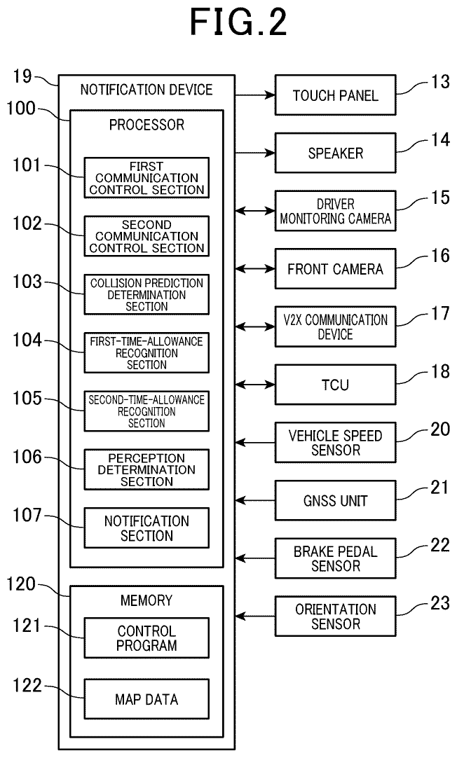

FIG. 2 shows a configuration of the notification device 19.

The touch panel 13, the speaker 14, the driver monitoring camera 15, the front camera 16, the V2X communication device 17, the TCU 18, a vehicle speed sensor 20, a global navigation satellite system (GNSS) unit 21, a brake pedal sensor 22, and an orientation sensor 23 are connected to the notification device 19.

The touch panel 13 displays various types of information in accordance with control by the notification device 19.

The speaker 14 outputs various sounds in accordance with control by the notification device 19.

The driver monitoring camera 15 performs capturing in accordance with control by the notification device 19.

The front camera 16 performs capturing in accordance with control by the notification device 19.

The V2X communication device 17 communicates with the other vehicle 2A, the terminal carried by the occupant of the bicycle 2B, and the terminal carried by the pedestrian 2C in accordance with control by the notification device 19.

The TCU 18 communicates with the equipment connected to the network NW in accordance with control by the notification device 19.

The vehicle speed sensor 20 detects the movement speed of the first mobile object 1. The vehicle speed sensor 20 detects the movement speed of the first mobile object 1 at predetermined intervals, and outputs the detected value indicating the detected movement speed of the first mobile object 1 to the notification device 19.

The GNSS unit 21 performs positioning of the current position of the first mobile object 1. The GNSS unit 21 generates position data indicating the current position of the first mobile object 1, and outputs the generated position data to the notification device 19.

The brake pedal sensor 22 detects the amount of operation of a brake pedal that decelerates the first mobile object 1. The brake pedal sensor 22 outputs the detected value to the notification device 19.

The orientation sensor 23 is a sensor that detects the movement orientation of the first mobile object 1. The movement orientation refers to an orientation corresponding to the direction of movement. The orientation sensor 23 outputs the detected value to the notification device 19.

The notification device 19 includes a processor 100, such as a central processing unit (CPU) or a microprocessor unit (MPU), a memory 120, and interface circuitry for connection with various devices.

The memory 120 is a storage device that stores a program and data. The memory 120 stores a control program 121, map data 122, and data to be processed by the processor 100. The memory 120 includes a non-volatile storage area. The memory 120 may include a volatile storage area, which may constitute a work area for the processor 100. The memory 120 is configured by using, for example, a read only memory (ROM) and a random access memory (RAM).

The control program 121 is a program that causes the processor 100 to function as functional units, which will be described later.

The map data 122 is data that stores road map information, building information, and the like. The road map information includes a road network obtained by representing roads on a map by lines, and includes information related to links obtained by dividing the road network into a plurality of parts based on crossroads, forks, and the like regarded as nodes, and defining each part between each pair of nodes as a link. The building information indicates the position of a building, the name of the building, the shape of the building when viewed from above, and the like.

The processor 100 functions as a first communication control section 101, a second communication control section 102, a collision prediction determination section 103, a first-time-allowance recognition section 104, a second-time-allowance recognition section 105, a perception determination section 106, and a notification section 107, by reading and executing the control program 121.

### 2-1. First Communication Control Section

The first communication control section 101 receives the current position of a second mobile object 2, the movement speed of the second mobile object 2, and the movement orientation of the second mobile object 2 via the V2X communication device 17.

The first communication control section 101 communicates with the other vehicle 2A via the V2X communication device 17 and receives, from the other vehicle 2A, the current position of the other vehicle 2A, the movement speed of the other vehicle 2A, and the movement orientation of the other vehicle 2A.

The first communication control section 101 communicates with the terminal carried by the occupant of the bicycle 2B via the V2X communication device 17. The first communication control section 101 receives the current position of the terminal carried by the occupant of the bicycle 2B, the movement speed of the terminal, and the movement orientation of the terminal, as the current position of the bicycle 2B, the movement speed of the bicycle 2B, and the movement orientation of the bicycle 2B, respectively.

The first communication control section 101 communicates with the terminal carried by the pedestrian 2C via the V2X communication device 17. The first communication control section 101 receives the current position of the terminal carried by the pedestrian 2C, the movement speed of the terminal, and the movement orientation of the terminal, as the current position of the pedestrian 2C, the movement speed of the pedestrian 2C, and the movement orientation of the pedestrian 2C, respectively.

Hereinafter, the current position of a second mobile object 2, the movement speed of the second mobile object 2, and the movement orientation of the second mobile object 2 are collectively referred to as “the information related to a second mobile object 2”.

### 2-2. Second Communication Control Section

The second communication control section 102 communicates with the server device 3 via the TCU 18.

### 2-3. Collision Prediction Determination Section

The collision prediction determination section 103 determines whether a collision between the first mobile object 1 and a second mobile object 2 is predicted. The collision prediction determination section 103 performs such determination, for each second mobile object 2 from which the information related to the second mobile object 2 is received.

The collision prediction determination section 103 determines whether a collision between the first mobile object 1 and a second mobile object 2 is predicted, for example, as follows.

The collision prediction determination section 103 determines a straight path that the first mobile object 1 will take, based on a map indicated by the map data 122, the current position of the first mobile object 1 determined by the GNSS unit 21, and the movement orientation of the first mobile object 1 detected by the orientation sensor 23.

Moreover, the collision prediction determination section 103 determines a straight path that the second mobile object 2 will take, based on the map indicated by the map data 122, and the information related to the second mobile object 2 received by the first communication control section 101.

Subsequently, the collision prediction determination section 103 determines whether the straight path of the second mobile object 2 intersects with the straight path of the first mobile object 1, and, when it is determined that the straight paths do not intersect, determines that a collision between the second mobile object 2 and the first mobile object 1 is not predicted.

When it is determined that the straight path of the second mobile object 2 intersects with the straight path of the first mobile object 1, the collision prediction determination section 103 calculates a required time period for the first mobile object 1 to arrive at a point (hereinafter, with a sign “CP” added, referred to as the crossing point CP) where the straight path of the second mobile object 2 intersects with the straight path of the first mobile object 1. The calculation is performed, by referring to the map indicated by the map data 122, based on the distance from the current position of the first mobile object 1 up to the crossing point CP, and on the movement speed of the first mobile object 1 detected by the vehicle speed sensor 20.

Moreover, when it is determined that the straight path of the second mobile object 2 intersects with the straight path of the first mobile object 1, the collision prediction determination section 103 calculates a required time period for the second mobile object 2 to arrive at the crossing point CP. The calculation is performed, by referring to the map indicated by the map data 122, based on the distance from the current position of the second mobile object 2 to the crossing point CP, and on the movement speed of the second mobile object 2.

When a difference between the required time period for the first mobile object 1 and the required time period for the second mobile object 2 is within a predetermined time period, the collision prediction determination section 103 determines that a collision between the second mobile object 2 and the first mobile object 1 is predicted. When the difference exceeds the predetermined time period, the collision prediction determination section 103 determines that a collision between the second mobile object 2 and the first mobile object 1 is not predicted.

### 2-4. First-Time-Allowance Recognition Section

The first-time-allowance recognition section 104 recognizes a first time allowance, for each second mobile object 2 with regard to which it is determined that a collision with the first mobile object 1 is predicted. The first time allowance is a time period left until the first mobile object 1 and the second mobile object 2 collide after the second mobile object 2 becomes visible from the first mobile object 1.

The first-time-allowance recognition section 104 in the present embodiment recognizes the first time allowance by calculating the first time allowance.

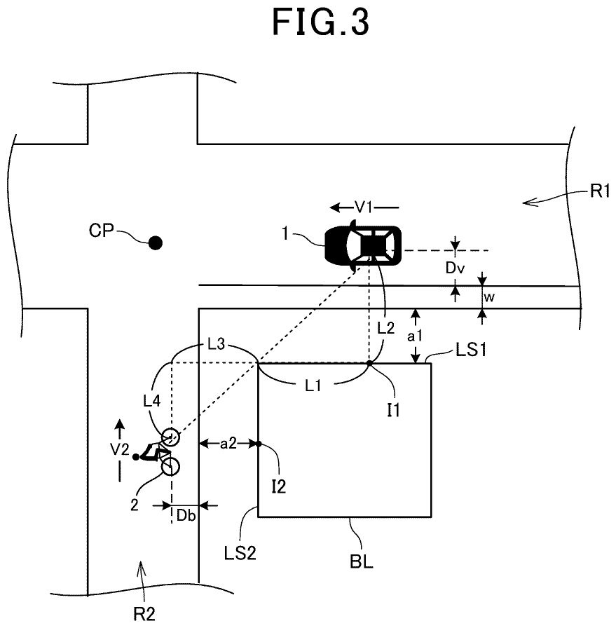

Here, the calculation of the first time allowance is described with reference to FIG. 3.

FIG. 3 is a diagram for describing the calculation of the first time allowance.

FIG. 3 illustrates a case where the first mobile object 1 is moving toward the left of the drawing on a road R1 that extends in right-left directions in the drawing. Moreover, FIG. 3 illustrates a case where a second mobile object 2 is moving toward the top of the drawing on a road R2 that extends in up-down directions in the drawing. Note that a black circle is depicted as the crossing point CP in FIG. 3.

The first-time-allowance recognition section 104 calculates the first time allowance by using following expressions (1) and (2).

T=((Dv+w+a1)/r+Db+a2)/V1 (1)

r=V2/V1 (2)

In expression (1), “T” represents the first time allowance.

In expression (1), “Dv” represents the distance from the first mobile object 1 to a sidewalk existing on the left side of the first mobile object 1.

In expression (1), “w” represents the width of the sidewalk existing on the left side of the first mobile object 1.

In expression (1), “a1” represents the distance from a building BL to the road R1 on which the first mobile object 1 is moving.

In expression (1), “Db” represents the distance from the second mobile object 2 to the right edge of the road R2 on which the second mobile object 2 is moving.

In expression (1), “a2” represents the distance from the building BL to the road R2 on which the second mobile object 2 is moving.

In expressions (1) and (2), “V1” represents the movement speed of the first mobile object 1.

In expression (2), “V2” represents the movement speed of the second mobile object 2.

Note that expression (1) is derived based on expressions (3) to (7).

L1=T×V1−(a2+Db) (3)

L2=a1+w+Dv (4)

L3=a2+Db (5)

L4=T×V1×r−(a1+w+Dv) (6)

L1:L2=L3:L4 (7)

The first-time-allowance recognition section 104 refers to the map data 122, and identifies the building BL that exists within a predetermined range from the crossing point CP, that exists to the left of the first mobile object 1, that exists to the right of the second mobile object 2, and that is the closest to the crossing point CP.

When the building BL cannot be identified, the first-time-allowance recognition section 104 performs the calculation by assuming that “T” in expression (1) is infinite. In other words, in such a case, the first-time-allowance recognition section 104 recognizes the first time allowance to be infinite.

When the building BL can be identified, the first-time-allowance recognition section 104 refers to the shape of the building BL included in the map data 122, and identifies a position (hereinafter, with a sign “I1” added, referred to as the first position I1) where the separation distance of the road R1 on which the first mobile object 1 is moving from the identified building BL is the smallest. In the case of FIG. 3, the first-time-allowance recognition section 104 identifies a position on a line segment LS1 as the first position I1. Subsequently, the first-time-allowance recognition section 104 calculates a first distance. The first distance is a distance in a direction orthogonal to the directions in which the road R1 extends, and is the separation distance between the identified first position I1 and the road R1. Then, the first-time-allowance recognition section 104 substitutes the calculated first distance for “a1” in expression (1).

When the building BL can be identified, the first-time-allowance recognition section 104 refers to the shape of the building BL included in the map data 122, and identifies a position (hereinafter, with a sign “I2” added, referred to as the second position I2) where the separation distance of the road R2 on which the second mobile object 2 is moving from the identified building BL is the smallest. In the case of FIG. 3, the first-time-allowance recognition section 104 identifies a position on a line segment LS2 as the second position I2. Subsequently, the first-time-allowance recognition section 104 calculates a second distance. The second distance is a distance in a direction orthogonal to the directions in which the road R2 extends, and is the separation distance between the identified second position I2 and the road R2. Then, the first-time-allowance recognition section 104 substitutes the calculated second distance for “a2”.

When the building BL can be identified, the first-time-allowance recognition section 104 refers to the map data 122 and calculates a third distance. The third distance is a distance in the direction orthogonal to the directions in which the road R1 extends, and is the distance from the left edge of the road R1 to the current position of the first mobile object 1 on the basis of the direction of movement of the first mobile object 1. Then, the first-time-allowance recognition section 104 substitutes the calculated third distance for “Dv+w” in expression (1). Note that the first-time-allowance recognition section 104 may obtain “Dv” and “w” individually and substitute the obtained values into expression (1).

When the building BL can be identified, the first-time-allowance recognition section 104 refers to the map data 122 and calculates a fourth distance. The fourth distance is a distance in the direction orthogonal to the directions in which the road R2 extends, and is the distance from the right edge of the road R2 to the current position of the second mobile object 2 on the basis of the direction of movement of the second mobile object 2. Then, the first-time-allowance recognition section 104 substitutes the calculated fourth distance for “Db” in expression (1).

When the building BL can be identified, the first-time-allowance recognition section 104 substitutes the movement speed of the first mobile object 1 detected by the vehicle speed sensor 20 for “V1” in expressions (1) and (2). Note that the first-time-allowance recognition section 104 substitutes, into expressions (1) and (2), the movement speed of the first mobile object 1 that is most recently detected when calculating the first time allowance.

When the building BL can be identified, the first-time-allowance recognition section 104 substitutes the received movement speed of the second mobile object 2 for “V2” in expression (2). Note that the first-time-allowance recognition section 104 substitutes, into expression (2), the movement speed of the second mobile object 2 that is most recently received when calculating the first time allowance.

The first-time-allowance recognition section 104 obtains T from expressions (1) and (2), and recognizes the obtained T as the first time allowance. Thus, the first-time-allowance recognition section 104 can obtain the first time allowance that is a time period left until the first mobile object 1 and the second mobile object 2 collide from a time point at which the second mobile object becomes visible from the first mobile object 1.

### 2-6. Second-Time-Allowance Recognition Section

The second-time-allowance recognition section 105 recognizes a second time allowance, for each second mobile object 2 with regard to which it is determined that a collision with the first mobile object 1 is predicted. The second time allowance refers to a time period left until the first mobile object 1 and the second mobile object 2 collide from the current time point.

The second-time-allowance recognition section 105 in the present embodiment recognizes the second time allowance by calculating the second time allowance.

For example, the second-time-allowance recognition section 105 refers to the map indicated by the map data 122, and identifies a crossing point CP, based on the current position of the first mobile object 1, the movement orientation of the first mobile object 1, the current position of the second mobile object 2, and the movement orientation of the second mobile object 2. Subsequently, the second-time-allowance recognition section 105 refers to the map indicated by the map data 122, and calculates the distance from the current position of the first mobile object 1 up to the crossing point CP. Subsequently, the second-time-allowance recognition section 105 calculates the second time allowance by dividing the calculated distance up to the crossing point CP by the movement speed of the first mobile object 1 most recently detected by the vehicle speed sensor 20.

Note that a scheme for calculating the second time allowance is not limited to the above-described example. For example, the second time allowance may be calculated by using an existing technique, based on the current position of the first mobile object 1, the movement speed of the first mobile object 1, the current position of the second mobile object 2, and the movement speed of the second mobile object 2.

### 2-7. Perception Determination Section

When it is determined that a collision with the first mobile object 1 is predicted, the perception determination section 106 determines whether the occupant P of the first mobile object 1 perceives the second mobile object 2.

Hereinafter, a plurality of schemes for determination by the perception determination section 106 is illustrated.

### 2-7-1. First Scheme for Determination

In a first scheme for determination, the perception determination section 106 performs determination, based on whether there is an operation, by the occupant P, of decelerating the first mobile object 1.

For example, the perception determination section 106 determines, based on a detected value of the brake pedal sensor 22, whether a brake pedal is operated. When it is determined that the brake pedal is operated, the perception determination section 106 assumes that there is an operation by the occupant P of decelerating the first mobile object 1, and determines that the occupant P perceives the second mobile object 2. When it is determined that the brake pedal is not operated, the perception determination section 106 assumes that there is not an operation by the occupant P of decelerating the first mobile object 1, and determines that the occupant P does not perceive the second mobile object 2.

For example, the perception determination section 106 determines, based on a detected value outputted by the vehicle speed sensor 20, whether the movement speed of the first mobile object 1 is a predetermined value or less. When it is determined that the movement speed of the first mobile object 1 is the predetermined value or less, the perception determination section 106 assumes that there is an operation by the occupant P of decelerating the first mobile object 1, and determines that the occupant P perceives the second mobile object 2. When it is determined that the movement speed of the first mobile object 1 is not the predetermined value or less, the perception determination section 106 assumes that there is not an operation by the occupant P of decelerating the first mobile object 1, and determines that the occupant P does not perceive the second mobile object 2.

For example, based on a detected value of an undepicted acceleration sensor, the perception determination section 106 determines that there is a deceleration operation when the absolute value of acceleration in a deceleration direction is a predetermined value or more, and otherwise, determines that there is not a deceleration operation.

### 2-7-2. Second Scheme for Determination

In a second scheme for determination, the perception determination section 106 performs determination, based on the direction of the line of sight of the occupant P. The perception determination section 106 detects the direction of the line of sight of the driver. The perception determination section 106 detects the direction of the line of sight of the driver, based on image data on a driver captured image. The perception determination section 106 detects the eyes of the driver from the driver captured image by using pattern matching, color, or the like, and detects, as the direction of the line of sight, a direction in which the detected eyes are pointed. Note that data required to detect eyes (shape data or color data on eyes) is stored in the memory 120. When the detected direction of the line of sight is a direction toward the second mobile object 2 on the basis of the first mobile object 1, the perception determination section 106 determines that the occupant P perceives the second mobile object 2. When the detected direction of the line of sight is not the direction toward the second mobile object 2 on the basis of the first mobile object 1, the perception determination section 106 determines that the occupant P does not perceive the second mobile object 2. Note that the perception determination section 106 grasps the relative position of and the relative direction toward the second mobile object 2 from the first mobile object 1, based on the map data 122, the current position of the first mobile object 1, and the received current position of the second mobile object 2.

As described above, schemes for determination by the perception determination section 106 are illustrated. The perception determination section 106 may perform determination by using any one of the first scheme for determination and the second scheme for determination, or may perform determination by using both the first scheme for determination and the second scheme for determination.

### 2-8. Notification Section

The notification section 107 notifies the risk of a collision between the first mobile object 1 and a second mobile object 2. The notification section 107 in the present embodiment performs notification by using the speaker 14. For example, the notification section 107 notifies the risk of a collision between the first mobile object 1 and a second mobile object 2 by outputting an alert sound via the speaker 14. For example, the notification section 107 notifies the risk of a collision between the first mobile object 1 and a second mobile object 2 by outputting a voice, such as “there is a risk of a collision”, via the speaker 14.

Note that the notification section 107 may notify the risk of a collision between the first mobile object 1 and a second mobile object 2 by displaying information on the touch panel 13. In such a case, the notification section 107 causes the touch panel 13 to display, for example, a character string of “Please beware ahead, or a collision may occur”, or causes the touch panel 13 to display a character string of “On a collision course, beware ahead!!!”.

### 3. Operation of Notification Device

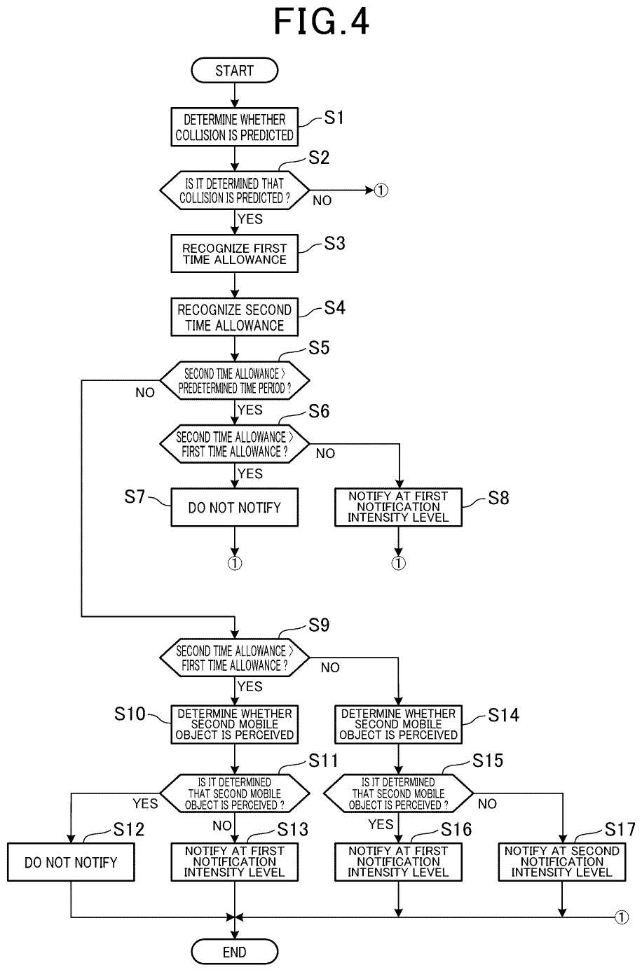

Next, operation of the notification device 19 according to the present embodiment is described. FIG. 4 is a flowchart showing the operation of the notification device 19.

The collision prediction determination section 103 determines whether a collision between the first mobile object 1 and a second mobile object 2 is predicted (step S1).

Subsequently, the first-time-allowance recognition section 104 determines whether it is determined in step S1 that a collision is predicted (step S2).

When it is not determined that a collision is predicted (step S2: NO), the processor 100 terminates the present processing.

When it is determined that a collision is predicted (step S2: YES), the first-time-allowance recognition section 104 recognizes a first time allowance (step S3).

Subsequently, the second-time-allowance recognition section 105 recognizes a second time allowance (step S4).

Subsequently, the notification section 107 determines whether the second time allowance recognized in step S4 is more than a predetermined time period (step S5). As an example, the predetermined time period can be seven seconds. However, the predetermined time period to be compared with the second time allowance is not limited to seven seconds, and may be shorter than seven seconds or longer than seven seconds.

When it is determined that the second time allowance is more than the predetermined time period (step S5: YES), the notification section 107 determines whether or not the second time allowance recognized in step S4 is more than the first time allowance recognized in step S3 (step S6).

When it is determined that the second time allowance is more than the first time allowance (step S6: YES), the notification section 107 does not notify the risk of a collision between the first mobile object 1 and the second mobile object 2 (step S7).

Note that the situation in step S7 is a situation where the second time allowance is more than the predetermined time period, and where the second mobile object 2 is not visible from the first mobile object 1.

When it is determined that the second time allowance is the first time allowance or less (step S6: NO), the notification section 107 notifies, at a first notification intensity level, the risk of a collision between the first mobile object 1 and the second mobile object 2 (step S8).

Note that the situation in step S8 is a situation where the second time allowance is more than the predetermined time period, and where the second mobile object 2 is visible from the first mobile object 1.

A notification intensity level refers to an intensity used to convey, to a notified person, the seriousness of information to be notified, and the intensity at the first notification intensity level is less than at the second notification intensity level. For example, when the notification section 107 performs notification by using the speaker 14, the volume of sound is lower in notification at the first notification intensity level than in notification at the second notification intensity level. For example, when the notification section 107 performs notification by using the touch panel 13, the size of characters displayed is smaller in notification at the first notification intensity level than in notification at the second notification intensity level.

Returning to the description of step S5, when it is determined that the second time allowance recognized in step S4 is the predetermined time period or less (step S5: NO), the notification section 107 determines whether the second time allowance recognized in step S4 is more than the first time allowance recognized in step S3 (step S9).

When the notification section 107 determines that the second time allowance is more than the first time allowance (step S9: YES), the perception determination section 106 determines whether the occupant P perceives the second mobile object 2 (step S10).

Note that the situation that goes for affirmative determination in step S9 is a situation where the second time allowance is the predetermined time period or less, and where the second mobile object 2 is not visible from the first mobile object 1.

Subsequently, the notification section 107 determines whether it is determined in step S10 that the occupant P perceives the second mobile object 2 (step S11).

When the notification section 107 determines that it is determined in step S10 that the occupant P perceives the second mobile object 2 (step S11: YES), the notification section 107 does not notify the risk of a collision between the first mobile object 1 and the second mobile object 2 (step S12).

When the notification section 107 determines that it is not determined in step S10 that the occupant P perceives the second mobile object 2 (step S11: NO), the notification section 107 notifies, at the first notification intensity level, the risk of a collision between the first mobile object 1 and the second mobile object 2 (step S13).

Returning to the description of step S9, when the notification section 107 determines that the second time allowance is the first time allowance or less (step S9: NO), the perception determination section 106 determines whether the occupant P perceives the second mobile object 2 (step S14).

Note that the situation that goes for negative determination in step S9 is a situation where the second time allowance is the predetermined time period or less, and where the second mobile object 2 is visible from the first mobile object 1.

Subsequently, the notification section 107 determines whether it is determined in step S14 that the occupant P perceives the second mobile object 2 (step S15).

When the notification section 107 determines that it is determined in step S14 that the occupant P perceives the second mobile object 2 (step S15: YES), the notification section 107 notifies, at the first notification intensity level, the risk of a collision between the first mobile object 1 and the second mobile object 2 (step S16).

When the notification section 107 determines that it is not determined in step S14 that the occupant P perceives the second mobile object 2 (step S15: NO), the notification section 107 notifies, at the second notification intensity level, the risk of a collision between the first mobile object 1 and the second mobile object 2 (step S17).

### 4. Other Embodiments

The above-described embodiment is only to show one aspect, and any modifications and applications can be made.

In another embodiment, the first time allowance may be recognized based on the height of the building BL and the height of a second mobile object 2. For example, in the case of this other embodiment, when the second mobile object 2 is higher than the building BL, the first time allowance is recognized to be infinite. For example, in the case of this other embodiment, when the height of the building BL is equal to or less than the height of the second mobile object 2, the first time allowance is recognized as in the above-described embodiment.

Note that the first time allowance is recognized based on the height of the building BL included in the map data 122 when the height of the building BL is included as information in the map data 122. The first time allowance is recognized based on the height of the building BL that is estimated from a front image.

In the case of this other embodiment, the height of the second mobile object 2 is based on reception by the V2X communication device 17. For example, when the V2X communication device 17 receives information related to a second mobile object 2 through vehicle-to-pedestrian communication, the first time allowance is calculated based on a predetermined height of the second mobile object 2, on the assumption that the second mobile object 2 is the pedestrian 2C or the bicycle 2B. For example, when the V2X communication device 17 receives information related to a second mobile object 2 through vehicle-to-vehicle communication, the first time allowance is calculated based on a height of the second mobile object 2 that is predetermined for each type of the other vehicle 2A. Note that the first mobile object 1 receives the type of the other vehicle 2A together with the information related to the second mobile object 2 through vehicle-to-vehicle communication.

In the above-described embodiment, the first-time-allowance recognition section 104 is configured to recognize the first time allowance by calculation. In another embodiment, the first-time-allowance recognition section 104 may recognize the first time allowance by acquiring the first time allowance from the server device 3. In the case of this other embodiment, the second communication control section 102 transmits, to the server device 3, the current position of the first mobile object 1, the movement speed of the first mobile object 1, the movement orientation of the first mobile object 1, the current position of the second mobile object 2, the movement speed of the second mobile object 2, and the movement orientation of the second mobile object 2. Then, in the case of this other embodiment, the server device 3 obtains the first time allowance, based on the information received from the first mobile object 1, and transmits the obtained first time allowance to the first mobile object 1.

In the above-described embodiment, the second-time-allowance recognition section 105 is configured to recognize the second time allowance by calculation. In another embodiment, the second-time-allowance recognition section 105 may recognize the second time allowance by acquiring the second time allowance from the server device 3. In the case of this other embodiment, the second communication control section 102 transmits, to the server device 3, the current position of the first mobile object 1, the movement speed of the first mobile object 1, the movement orientation of the first mobile object 1, the current position of the second mobile object 2, the movement speed of the second mobile object 2, and the movement orientation of the second mobile object 2. Then, in the case of this other embodiment, the server device 3 obtains the second time allowance, based on the information received from the first mobile object 1, and transmits the obtained second time allowance to the first mobile object 1.

In the above-described embodiment, the notification section 107 is configured to perform notification through sound output or display. In another embodiment, the notification section 107 may perform notification by using another scheme. For example, the notification section 107 may perform notification by vibrating a seatbelt worn by the driver. In another embodiment, the notification section 107 may perform notification by combining a plurality of schemes. For example, the notification section 107 may perform notification by outputting sound and also vibrating the seatbelt.

In the above-described embodiment, the notification section 107 is configured to change notification forms by changing notification intensity levels. In another embodiment, the notification section 107 may change notification forms by turning on and off notification, or by changing schemes for notification (for example, changing from sound output to display).

In another embodiment, at least any one of the collision prediction determination section 103, the first-time-allowance recognition section 104, the second-time-allowance recognition section 105, and the perception determination section 106 may be executed as a function of a processor of the server device 3 connected to the network NW. When at least any one of the collision prediction determination section 103, the first-time-allowance recognition section 104, and the second-time-allowance recognition section 105 functions on the processor of the server device 3, the first mobile object 1 transmits, to the server device 3, the current position of the first mobile object 1, the movement speed of the first mobile object 1, the movement orientation of the first mobile object 1, the current position of a second mobile object 2, the movement speed of the second mobile object 2, and the movement orientation of the second mobile object 2. When the perception determination section 106 functions on the processor of the server device 3, the first mobile object 1 transmits, to the server device 3, a detected value of the vehicle speed sensor 20, a detected value of the brake pedal sensor 22, image data on a driver image, and the like.

In another embodiment, the processes by the V2X communication device 17 may be performed instead by a mobile terminal brought into the vehicle 1. In such a case, the mobile terminal brought into the vehicle 1 receives, from a server or the like, the current position of a second mobile object 2, the movement speed of the second mobile object 2, and the movement orientation of the second mobile object 2.

In another embodiment, the processes by the TCU 18 may be performed instead by a mobile terminal brought into the vehicle 1. In such a case, the mobile terminal brought into the vehicle 1 acquires from the notification device 19 and transmits to the server device 3 the current position of the first mobile object 1, the movement speed of the first mobile object 1, the movement orientation of the first mobile object 1, the current position of a second mobile object 2, the movement speed of the second mobile object 2, and the movement orientation of the second mobile object 2.

In another embodiment, the processes by the notification device 19 may be performed instead by a mobile terminal brought into the vehicle 1. In the case of this other embodiment, the mobile terminal implements the functionality of the perception determination section 106 by acquiring information (the speed of the vehicle 1, the direction of the line of sight of the occupant P, and the like) from the vehicle 1. Note that in the case of this other embodiment, the mobile terminal acquires the information from the vehicle 1 by performing wired or wireless communication with the vehicle 1.

The processor 100 may be configured by using a plurality of processors, or by using a single processor. The processor 100 may be hardware programmed in such a manner as to implement the functional units described above. In such a case, the processor 100 is configured by using, for example, an application specific integrated circuit (ASIC) or a field programmable gate array (FPGA).

The internal configuration of the first mobile object 1 shown in FIG. 2 is an example, and a specific form of implementation thereof is not limited. In other words, hardware pieces respectively corresponding to the individual units do not necessarily need to be mounted, and it is also naturally possible to make a configuration in which a single processor implements the individual units by executing a program. Moreover, one or some of the functions implemented by using software in the above-described embodiment may be configured as hardware, or one or some of the functions implemented by hardware may be implemented by using software.

The step units of the operation shown in FIG. 4 are configured by division according to major processes. The present invention is not limited by the way of division into or the names of units of processing. Division may be made into more step units, depending on processes. Division may be made in such a manner that one step unit includes more processes. Moreover, order of the steps may be changed as appropriate within a scope that does not impair the gist of the present invention.

When the communication method performed by the notification device 19 is implemented by using the processor 100, the program to be executed by the processor 100 can also be configured in the form of a recording medium or a transmission medium that transmits the program. In other words, the control program 121 can also be implemented in a state where the control program 121 is recorded on a removable information recording medium. Although examples of the information recording medium include magnetic recording media such as a hard disk, optical recording media such as a CD, and semiconductor storage devices such as a universal serial bus (USB) memory and a solid state drive (SSD), other recording media can also be used.

### 5. Configurations Supported by the Embodiments

The embodiments support following configurations.

### Configuration 1

A notification device including: a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and a notification section that notifies a risk of the collision between the first mobile object and the second mobile object to an occupant of the first mobile object, wherein the notification section changes a notification form, based on the first time allowance.

The notification device according to configuration 1 can change the notification form, with consideration given to a time period left until a collision with the second mobile object occurs after the second mobile object becomes visible. Accordingly, the notification form can be restrained from being changed too early or too late with respect to the timing of the second mobile object becoming visible, so the notification form can be changed as appropriate in a situation where a change of notification form is required. Accordingly, the risk of colliding with the other mobile object can be appropriately notified.

### Configuration 2

The notification device according to configuration 1, wherein the first time allowance is a time period based on a map around the first mobile object, a position of the first mobile object, and a position of the second mobile object, the map including a shape of a building.

The notification device according to configuration 2 can correctly grasp the timing of the second mobile object becoming visible by using the first time allowance based on the map including the shape of the building, the position of the first mobile object, and the position of the second mobile object. Accordingly, the risk of colliding with the other mobile object can be more appropriately notified.

### Configuration 3

The notification device according to configuration 1 or 2, further including a second-time-allowance recognition section that, when the collision between the first mobile object and the second mobile object is predicted, recognizes a second time allowance that is a time allowance before the first mobile object and the second mobile object collide from a current time point, wherein the notification section changes the notification form, based on a relation in magnitude between the first time allowance and the second time allowance.

The notification device according to configuration 3 can change the notification form, based on the relation in magnitude between the first time allowance and the second time allowance and, thus, based on whether the second mobile object is visible in a situation where a collision with the other mobile object is imminent. Accordingly, the risk of colliding with the other mobile object can be more appropriately notified.

### Configuration 4

The notification device according to configuration 3, wherein the notification section, when the second time allowance is less than the first time allowance, notifies, at a first notification intensity level, the risk of the collision between the first mobile object and the second mobile object, and, when the second time allowance is the first time allowance or more, notifies, at a second notification intensity level, the risk of the collision between the first mobile object and the second mobile object, the second notification intensity level being greater than the first notification intensity level.

The notification device according to configuration 4 performs notification at a greater notification intensity level from a timing at which the second mobile object has not yet become visible, whereby an occupant can be aware of the notification before the timing of the second mobile object becoming visible. Accordingly, the occupant of the first mobile object can be restrained from being surprised or feeling annoyed at notification made after the timing of the second mobile object becoming visible.

### Configuration 5

The notification device according to any one of configurations 1 to 4, further including a perception determination section that determines whether the occupant perceives the second mobile object, wherein the notification section changes the notification form, based on a result of determination by the perception determination section.

The notification device according to configuration 5 restrains notification from being performed in an unchanged form despite the fact that the occupant of the first mobile object perceives the second mobile object. Accordingly, the occupant of the first mobile object can be restrained from feeling annoyed at notification.

### Configuration 6

The notification device according to configuration 5, wherein the notification section, when the perception determination section determines that the occupant perceives the second mobile object, notifies, at a first notification intensity level, the risk of the collision between the first mobile object and the second mobile object, and, when the perception determination section determines that the occupant does not perceive the second mobile object, notifies, at a second notification intensity level, the risk of the collision between the first mobile object and the second mobile object, the second notification intensity level being greater than the first notification intensity level.

When it is determined that the occupant of the first mobile object perceives the second mobile object, the notification device according to configuration 6 notifies the risk of colliding with the other mobile object at a lower notification intensity level than when it is determined that the occupant does not perceive. Accordingly, notification can be restrained from being performed at a greater notification intensity level despite the fact that the occupant of the first mobile object perceives the second mobile object. Accordingly, the occupant of the first mobile object can be restrained from feeling annoyed at notification.

### Configuration 7

The notification device according to configuration 5 or 6, wherein the perception determination section performs determination, based on whether there is an operation, by the occupant, of decelerating the first mobile object.

When the occupant of the first mobile object perceives the second mobile object, it is highly probable that an operation of decelerating the first mobile object is performed. Accordingly, the notification device according to configuration 7 can correctly determine whether the occupant of the first mobile object perceives the second mobile object.

### Configuration 8

The notification device according to configuration 5 or 6, wherein the perception determination section performs determination, based on a direction of a line of sight of the occupant.

When the occupant of the first mobile object perceives the second mobile object, it is highly probable that the line of sight of the occupant of the first mobile object is pointed at the second mobile object. Accordingly, by performing determination based on the direction of the line of sight of the occupant of the mobile object, the notification device according to configuration 8 can correctly determine whether the occupant of the first mobile object perceives the second mobile object.

### Configuration 9

The notification device according to any one of configurations 1 to 8, wherein the first time allowance is a time period based on a relation between a height of the building and a height of the second mobile object.

When the second mobile object is visible regardless of the height of the building, the notification device according to configuration 9 can recognize the first time allowance by assuming that the second mobile object is visible regardless of the height of the building. Accordingly, the notification form can be restrained from being unnecessarily changed.

### Configuration 10

A notification method that is performed by a notification device, the notification method including: when a collision between a first mobile object and a second mobile object existing around the first mobile object is predicted, recognizing a first time allowance that is a time allowance before the first mobile object and the second mobile object collide after the second mobile object becomes visible from the first mobile object; and notifying a risk of the collision between the first mobile object and the second mobile object to an occupant of the first mobile object, wherein the notifying changes a notification form, based on the first time allowance.

The notification method according to configuration 10 brings about effects similar to those of the notification device according to configuration 1.

### Configuration 11

A notification system including: a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and a notification section that notifies a risk of the collision between the first mobile object and the second mobile object to an occupant of the first mobile object, wherein the notification section changes a notification form, based on the first time allowance.

The notification system according to configuration 11 brings about effects similar to those of the notification device according to configuration 1.

### REFERENCE SIGNS LIST

1 first mobile object, 2 second mobile object, 2A other vehicle, 2B bicycle, 2C pedestrian, 3 server device, 10A driver seat, 10B passenger seat, 10C rear right seat, 10D rear left seat, 12 dashboard, 13 touch panel, 14 speaker, 15 driver monitoring camera, 16 front camera, 17 V2X communication device, 18 TCU, 19 notification device, 20 vehicle speed sensor, 21 GNSS unit, 22 brake pedal sensor, 23 orientation sensor, 100 processor, 101 first communication control section, 102 second communication control section, 103 collision prediction determination section, 104 first-time-allowance recognition section, 105 second-time-allowance recognition section, 106 perception determination section, 107 notification section, 120 memory, 121 control program, 122 map data, 1000 notification system, BL building, CP crossing point, HD head, LS1 line segment, LS2 line segment, NW network, P occupant, R1 road, R2 road

1. A notification device comprising:
a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and
a notification section that notifies a risk of the collision between the first mobile object and the second mobile object to an occupant of the first mobile object,
wherein the notification section changes a notification form, based on the first time allowance.

2. The notification device according to claim 1, wherein the first time allowance is a time period based on a map around the first mobile object, a position of the first mobile object, and a position of the second mobile object, the map including a shape of a building.

3. The notification device according to claim 1, further comprising a second-time-allowance recognition section that, when the collision between the first mobile object and the second mobile object is predicted, recognizes a second time allowance that is a time allowance before the first mobile object and the second mobile object collide from a current time point,
wherein the notification section changes the notification form, based on a relation in magnitude between the first time allowance and the second time allowance.

4. The notification device according to claim 3, wherein the notification section,
when the second time allowance is less than the first time allowance, notifies, at a first notification intensity level, the risk of the collision between the first mobile object and the second mobile object, and
when the second time allowance is the first time allowance or more, notifies, at a second notification intensity level, the risk of the collision between the first mobile object and the second mobile object, the second notification intensity level being greater than the first notification intensity level.

5. The notification device according to claim 1, further comprising a perception determination section that determines whether the occupant perceives the second mobile object,
wherein the notification section changes the notification form, based on a result of determination by the perception determination section.

6. The notification device according to claim 5, wherein the notification section,
when the perception determination section determines that the occupant perceives the second mobile object, notifies, at a first notification intensity level, the risk of the collision between the first mobile object and the second mobile object, and
when the perception determination section determines that the occupant does not perceive the second mobile object, notifies, at a second notification intensity level, the risk of the collision between the first mobile object and the second mobile object, the second notification intensity level being greater than the first notification intensity level.

7. The notification device according to claim 5, wherein the perception determination section performs determination, based on whether there is an operation, by the occupant, of decelerating the first mobile object.

8. The notification device according to claim 5, wherein the perception determination section performs determination, based on a direction of a line of sight of the occupant.

9. The notification device according to claim 2, wherein the first time allowance is a time period based on a relation between a height of the building and a height of the second mobile object.

10. A notification method that is performed by a notification device, the notification method comprising:
when a collision between a first mobile object and a second mobile object existing around the first mobile object is predicted, recognizing a first time allowance that is a time allowance before the first mobile object and the second mobile object collide after the second mobile object becomes visible from the first mobile object; and
notifying a risk of the collision between the first mobile object and the second mobile object to an occupant of the first mobile object,
wherein the notifying changes a notification form, based on the first time allowance.

11. A notification system comprising:
a first-time-allowance recognition section that, when a collision between a first mobile object and a second mobile object existing around the first mobile object is predicted, recognizes a first time allowance that is a time allowance before the first mobile object and the second mobile object collide after the second mobile object becomes visible from the first mobile object; and
a notification section that notifies a risk of the collision between the first mobile object and the second mobile object to an occupant of the first mobile object,
wherein the notification section changes a notification form, based on the first time allowance.
